(19) United States
(12) Patent Application Publication
(10) Pub. No.: US 2017/0058589 A1
(43) Pub. Date: Mar. 2, 2017

(54) SELF-INFLATING FLOOD BARRIER

(71) Applicant: Floodsense Innovations Limited, Swaffham (GB)

(72) Inventor: Kevin Nigel Williams, Swaffham (GB)

(21) Appl. No.: 15/245,936

(22) Filed: Aug. 24, 2016

(30) Foreign Application Priority Data
Aug. 24, 2015 (GB) GB1515018.8

(51) Int. Cl. E05F 15/71; E04H 9/14; E06B 5/10; E06B 7/16; E05F 15/60; E05F 15/56

(52) U.S. Cl. CPC E05F 15/71; E05F 15/60; E05F 15/56; E06B 5/10; E06B 7/16; E04H 9/145

(57) ABSTRACT

An inflatable barrier (10) including a wall member (12) which includes at least one inflatable element, and at least one frame member (22), the frame member (22) including a guide formation (16), the at least one guide formation (16) including a channel in which at least a part of a corresponding guide member (24), which is carried by the wall member (12), is receivable, wherein in use, at least a part of the guide member (24) is able to travel along the channel of the guide formation (16), to at least assist in erecting the wall member (16) from an inactive position to an in use position.

### CROSS-REFERENCE TO RELATED APPLICATIONS

This application claims priority under 35 U.S.C. §119 to Great Britain Application No. GB 1515018.8 filed Aug. 24, 2015, herein incorporated by reference in its entirety.

### DESCRIPTION OF INVENTION

The invention relates to a barrier, in particular, but not exclusively to an inflatable flood barrier, which is configured to be automatically erected in response to a signal, for example in the event of an indication of flood water being detected in the vicinity of the barrier.

It is known to attempt to prevent the ingress of flood water into buildings, and to attempt to prevent the flow of flood water into certain areas of land. For example, it is known to provide side bars which can be permanently installed adjacent to or inside a doorway, and into which panels can be manually inserted, for example when a flood is expected, to provide a substantially watertight barrier which fills at least a lower portion of the doorway. An alternative type of known barrier is an inflatable barrier which includes one or more ‘tubes’ of material which can be filled with gas, e.g. air, to form a semi-rigid structure.

Disadvantages of known barriers include the need to manually erect the barrier in advance, and inflatable barriers can be bulky and unsightly. Furthermore, the positioning of inflatable barriers can be difficult to control as the barrier may move during inflation. The present invention aims to ameliorate disadvantages of known barriers.

In accordance with the present invention, there is provided an inflatable barrier including a wall member which includes at least one inflatable element, and at least one frame member, the frame member including a guide formation, the at least one guide formation including a channel in which at least a part of a corresponding guide member, which is carried by the wall member, is receivable, wherein in use, at least a part of the guide member is able to travel along the channel, to at least assist in erecting the wall member from an inactive position to an in use position.

The inflatable barrier may include a pair of guide formations, and the wall member may include a pair of guide members, each of which corresponds with and is at least partially receivable in one of the guide formations.

The wall member may be manufactured from drop-stitch material.

The wall member include a pair of faces, each of which may be substantially planar when the wall member is erected, and/or the pair of faces may be substantially parallel with one another.

The or each guide member may include a wheel, at least a part of which is receivable in the channel of the corresponding guide formation.

The or each guide formation may form part of a frame, which may further include a base member.

The base member may extend substantially perpendicularly to the or each guide formation.

The barrier may include an anchor to retain the wall member in a desired position relative to a part of the frame.

The anchor may include a Keder rail which is attached to or integral with at least one of the base member and the or each guide formation.

The wall member may include a Keder rope which is at least partially receivable in the Keder rail.

The Keder rope may be attached to the wall member.

The inflatable barrier may include at least one seal, for sealing the wall member to the frame.

The inflatable barrier may include an inflation apparatus, which is operable to inflate the wall member.

The inflatable barrier may be erectable automatically, by the inflation apparatus being operated in response to a signal provided to a control unit of the inflatable barrier.

The signal may include an electronic signal. The signal may be provided by a sensor, for example a moisture sensor.

The inflatable barrier may be manually operable, and manual operation of the inflatable barrier may override automatic operation of the inflatable barrier.

The inflatable barrier may include an energy source, which may be a battery, which may be for use as a back-up energy supply.

According to a second aspect of the invention, there is provided a barrier system including a plurality of barriers, at least one of which is an inflatable barrier according to the first aspect of the invention.

The invention will now be described, by way of example only, with reference to the accompanying drawings, of which

FIG. 1A is a front view of a part of a barrier;

FIG. 1B is a perspective view of a part of the barrier of FIG. 1A;

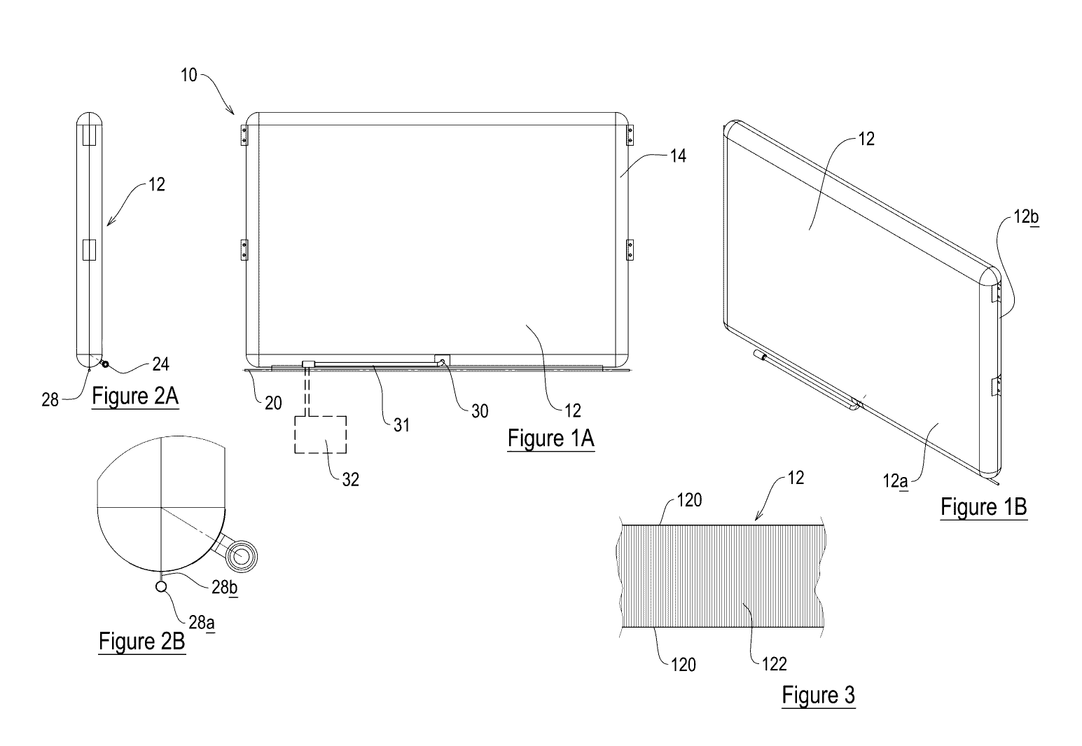

FIG. 2A is a side view of a wall member of the barrier of FIGS. 1A and 1B;

FIG. 2B is an enlarged view of a part of FIG. 2A;

FIG. 3 is an illustrative view of a part of the wall member of FIG. 2A;

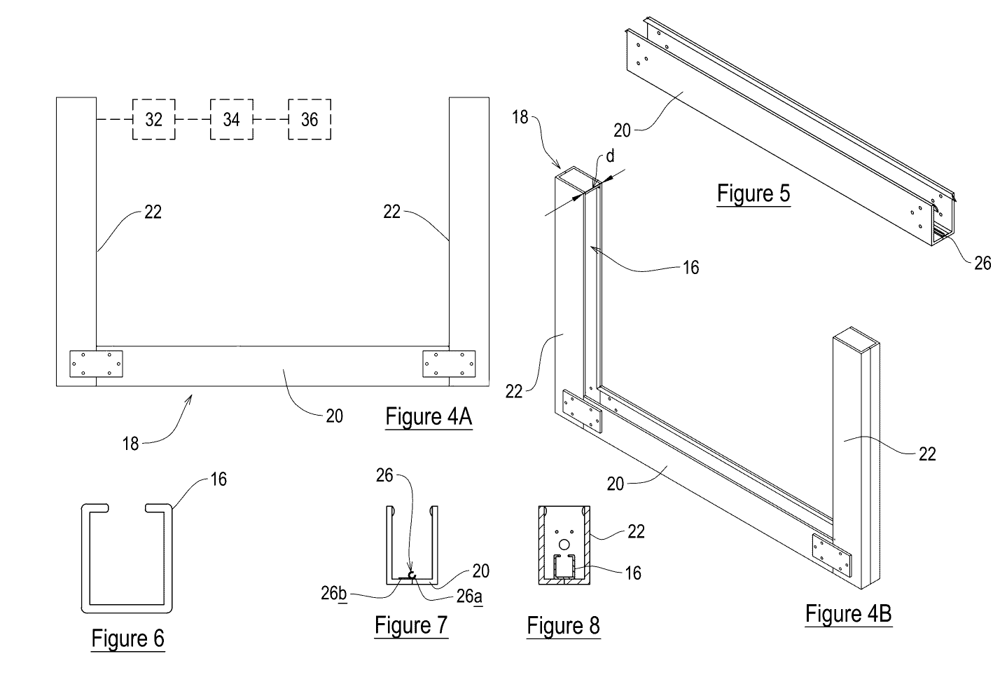

FIG. 4A is a front view of a frame of a barrier;

FIG. 4B is a perspective view of the frame of FIG. 4A;

FIG. 5 is a perspective view of a base member of the frame of FIGS. 4A and 4B;

FIG. 6 is a plan view of a guide member of the barrier;

FIG. 7 is a side view of the base member of FIG. 5;

FIG. 8 is a plan view of a side member of the frame of FIG. 4; and

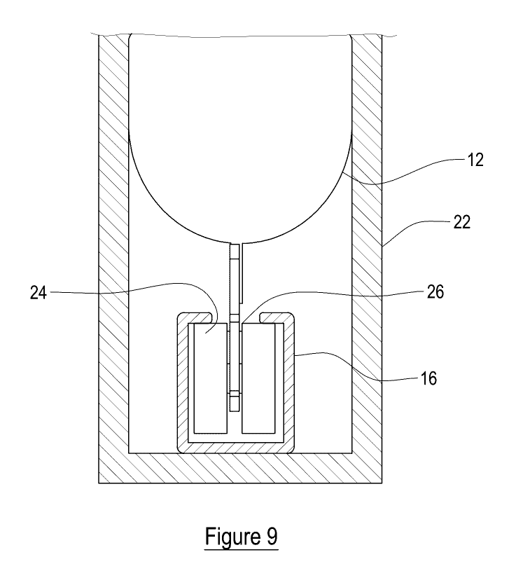

FIG. 9 is a plan view of a side member of the frame of FIG. 4, showing a part of the wall member in position relative to the side member.

Referring now to the drawings, there is provided an inflatable barrier 10, which includes a wall member 12. The wall member 12 includes at least one inflatable element 14. The wall member 12 includes a pair of faces 12a, 12b, each of which may be substantially planar when the wall member is erected, and/or the pair of faces may be substantially parallel with one another.

In the present example, the wall member 12 is manufactured from ‘drop-stitch’ material, which is a highly durable, synthetic material which includes a large number of threads 122 manufactured from, for example, polyester, each of the threads being attached between a pair of sheets 120 of material, which may also be manufactured from polyester. One of the pair of sheets forms or is adjacent the front face 12a of the wall member 12, and the other of the pair of sheets forms or is adjacent the rear face 12b of the wall member 12. The use of dropstitch material enables the wall member 12 to be inflated, and to provide a relatively rigid barrier, which may advantageously include at least one substantially planar surface. The wall member 12 may optionally be coated with a waterproof layer on at least one external surface, for example on at least one of the front face 12a and the rear face 12b.

The inflatable barrier 10 also includes a frame 18. In the present example, the frame 18 includes a plurality of frame member, including a base member 20, which has a substantially U-shaped cross section, as shown in FIGS. 5 and 7, for example. Attached to the base member 20 are a pair of further frame mebers, in the form of side members 22, which are also substantially U-shaped in cross-section. In the present example, the side members 22 are substantially parallel with one another, and substantially perpendicular to the base member 20.

It will be appreciated that the number of members 20, 22 required to provide an appropriate frame 18 may vary depending upon the application, and desired size and/or position of the inflatable barrier 10. The size and shape of each of the members 22, 24 of the frame 18 may also vary as necessary or as desired.

The base member 20 and/or the or each side member 22 is preferably manufactured from aluminium and/or steel, although it will be appreciated that other materials may be desirable, or necessary.

The inflatable barrier 10 includes at least one guide formation 16, which is preferably attached to a side member 22 of the frame 18. In the present example, two guide formations 16 are provided, one attached to each of the side members 22. Each guide formation 16 is substantially U-shaped in cross-section, so as to provide a channel. A part of the wall member 12, for example a part of the perimeter of the wall member 12, may be receivable in the channel provided by the or each guide formation. Additionally or alternatively, a guide member 24, at least a part of which is receivable in a corresponding part of one of the guide formations 16. The or each guide member 24 may be a rotating device, for example a wheel or castor device, which may roll along the channel formed by the corresponding guide formation 16. The or each guide member 24 may be of any appropriate alternative form. The or each guide member 24 may have a substantially C-shaped profile, or may have a profile which enables an attachment member 26 to rotatably attach the guide member 24 to the wall member 12. The attachment member 26 may include a substantially flexible fibre, which may be, for example, rope or a rope-like material. Additionally or alternatively the attachment member 26 may include a substantially rigid element, for example a pin or rod.

The depth d of the or each guide formation 16 may be determined by the corresponding depth of the wall member 12. Each guide formation 16 is attached to a corresponding side member 22, and in the present example lies inside the corresponding side member 22.

It will be appreciated that the size, shape of the or each guide formation 16, and the quantity thereof may vary as necessary, or as desired.

The inflatable barrier 10 also includes an anchor apparatus which includes an anchor formation 26 and an anchor member 28, at least a part of which is receivable in the anchor formation. The anchor formation 26 is attached to the base member 20 of the frame 18, and the anchor member 28 is attached to a part of the wall member 12, in the present example to bottom part of the wall member. The anchor formation 26 includes a hook formation 26a, which is substantially C-shaped in cross-section. The anchor formation 26 also includes an attachment part 26b, which is attachable to the base member 20, include the U-shaped cross-section of the base member 20. The length of the anchor formation 26 may correspond with the length of the base member 20, or may vary therefrom as appropriate. The anchor member 28 includes a rod 28a, which is substantially circular in cross section, and a connecting part 28b which connects the rod 28a to the wall member 12. It will be appreciated that the hook formation 26a and the rod 28a need not be substantially C-shaped nor circular in cross-section. However, it is advantageous for the hook formation 26a and the rod 28a to have corresponding cross-sectional shapes, such that the rob 28a is at least partially receivable in the hook formation 26a. The connecting formation 28a of the anchor member 28 is able to pass through an opening in the hook formation 26a.

The purpose of the anchor apparatus 26, 28 is to retain the wall member 12 in a desired position relative to at least a part of the frame 18, particularly during erection of the barrier 10, but also when the wall member is in an inactive position relative to the frame 18, and when it the wall member 12 is in an in use position relative to the frame 18. In the present example, the wall member 12 is at least semi-permanently connected to the base member 20 by virtue of the anchor apparatus. It will be appreciated that other methods of connecting the wall member 12 to the frame 18 may be appropriate and possible. It may be desirable for the wall member 12 to be removable from the frame 18 or for the wall member 12 to be permanently connected to the frame 18. It will be appreciated that the anchor formation 26 need not be attached to the base member 20 (and hence, the anchor member 28 need not be attached to the bottom of the wall member 12). The anchor formation 26 may be provided on another part of the frame 18, for example on one or more of the side parts 22, or may be provided adjacent the guide formations 16, on a part of an alternative structure, for example a floor or a door or window frame. Other positions of the anchor formation may also be appropriate. The position of the anchor member 28 on the wall member 12 is dependent upon the position of the anchor formation 26.

The anchor member 28 may be integral with the wall member 12, and/or the anchor formation 26 may be integral with a part of the frame 18.

In the present example, the anchor formation 26 includes a Keder rail or track, and the anchor member 28 is a Keder rope.

The inflatable barrier may optionally include at least one seal, for sealing at least a part of the wall member 12 to at least a part of the frame 18. The seal may be manufactured from a flexible or semi-flexible material, and may be attached around at least part of the perimeter of the wall member 12. The seal may include a pair of seals, one of which is positioned adjacent the front face 12a of the wall member 12 (and correspondingly a front face of the frame 18), and one of which is positioned adjacent the rear face 12b of the wall member 12 (and correspondingly a rear face of the frame 18).

In the present example, the wall member 12 includes an inlet 30 through which pressurised fluid, for example air, is receivable in at least a portion of the wall member 12. The inlet 30 is preferably welded and/or stitched into the wall member 12. The inlet 30 is shown at the bottom of the wall member in FIG. 1A but the position relative to the wall member 12 is not relevant for the purposes of the present invention. The barrier 10 includes an inflation apparatus which is connectable to the inlet 30, to enable the inflation of the wall member 12. The inlet 30 may include a valve to inhibit egress of pressurised air from the wall member 12 other than when desired. The inflation apparatus includes an air supply 32 (shown in dotted lines in FIG. 1A, as the position of the air supply 32 relative to the wall member 12 is not important) which is fluidly communicable with the wall member 12 via a conduit 31 and the inlet 30. The air supply 32 is preferably a stand-alone compressed air cylinder, but may alternatively be a machine shop compressor, or similar.

The inflation apparatus also preferably includes a control unit 34, which is operable to control the air supply 32. The inflation apparatus also preferably includes a power supply 36, which may include a battery to provide electrical power to the air supply 32 and/or to the control unit 34. The power supply 36 may be a ‘back-up’ power supply in the event of failure of an alternative power supply, for example mains supply or a generator, which may be utilised to provide electrical power to the air supply 32 and/or the control unit 34.

The inflation apparatus also includes at least one sensor 38 which is operable to sense one or more conditions in which it is desirable to erect the barrier 10. The sensor 38 is operable to provide an electronic signal to the control unit 34 in the event that it identifies one or more of the conditions in which it is desirable to erect the barrier 10. The or each sensor 38 may be a moisture sensor, or float switch, which may directly detect the presence and/or level of water, for example. Alternatively the or each sensor 38 may be a pressure sensor, with the control unit being able to imply the presence of flood water by the simultaneous operation of multiple sensors 38, for example.

The inflation apparatus also includes a regulator and a pressure switch to control the flow of air from the air supply 32 into the inlet 30 of the wall member 12, and to regulate the pressure of the air being supplied to the wall member 12. The purpose of the regulator and pressure switch is to prevent over-inflation of the wall member 12, and may also be used to detect a drop in air pressure in the wall member 12, which may indicate a failure or imminent failure of the barrier 10.

A barrier system including a plurality of barriers, at least one of which is an inflatable barrier which includes some or all of the features of the inflatable barrier 10, described above, is also envisaged. The barriers 10 are linked so as to enable substantially simultaneous inflation of two or more of the barriers 10, and/or to enable sequential inflation of the barriers 10. Alternatively, one or more of the barriers 10 in the system may be independently operable.

In use, the frame 18 (where provided) is positioned in an opening of a building which would allow water to enter the building in the event of a flood, for example a door or window. Each such opening is provided with a respective frame 18.

It will be appreciated that in some applications, for example where space is at a premium, it may be appropriate to attach one or more guide formations 16 to an existing structure, for example a doorframe, or wall, rather than providing separate frame members 20, 22.

Where a frame 18 is not used, the or each opening is provided with at least one guide formation 16. The wall member 12 is provided in an inactive position relative to the or each guide member and/or the frame 18, which does not significantly obstruct the opening when the barrier 10 is not in use.

Rather than installing a barrier 10 in each opening of a building, a barrier system including one or more barriers 10 may encircle a building or an area which is to be protected from the ingress of floodwater. Such a system may be achieved by providing one or more pillars to which a corresponding guide formation 16 may be attached (either with or without a frame member 18), and the or each wall member 12 which is required to span the gap(s) between the pillar(s) is provided in an appropriate configuration to prevent the ingress of floodwater into the building or area.

In the event of the sensor 38 indicating to the control unit 34 the presence of flood water or the imminent presence of flood water in the vicinity of the or each opening in the building, the control unit operates the barrier 10 automatically, by providing enabling power to be provided to the air supply 32, and for the air supply 32 to provide pressurised air to the or each wall member 12. As air inflates the or each wall member 12, the part of the or each wall member 12 which is receivable in the or each guide formation 16 (for example the guide member 24) is able, in use, to travel along at least a part of the corresponding guide formation 16, to assist in erecting the wall member 12, and hence the barrier 10. The wall member 12 is erected substantially straight and upright (in accordance with the position of the or each guide formation 16 and/or the frame 18). Since the wall member 12 is manufactured from drop-stitch material, the front and rear faces 12a, 12b of the or each wall member 12 are substantially planar and substantially perpendicular with one another. The wall member 12 is extremely rigid, and able to withstand high pressures exerted by flood water.

Once the or each wall member 12 is positioned in its in use (i.e. substantially upright) position, the control unit continues to control the flow of air from the air supply 32 to the or each wall member 12, to ensure that the wall member achieves the desired air pressure. The control unit 34 may then maintain the air pressure within the wall member, by monitoring the pressure, and adjusting the flow of air from the air supply 32 to the inlet 30 of the wall member 12 accordingly.

The inflation system of the or each barrier 10 may be operated to inflate the or each wall member 12 in ‘automatic’ mode, as described above or in manual mode. The manual mode may be used to override the automatic system.

When the flood water has receded, the or each barrier 10 is returned to its inactive mode, by deflating the or each wall member 12. The de-pressurisation of the or each wall member 12 is preferably carried out manually, so as to avoid the inadvertent deflation of the barrier before the flood water has receded, for example in the event of a failure of the control system.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

What is claimed is:

1: An inflatable barrier comprising a wall member which includes at least one inflatable element, and at least one frame member, the frame member including a guide formation, the at least one guide formation including a channel in which at least a part of a corresponding guide member, which is carried by the wall member, is receivable, wherein in use, at least a part of the guide member is able to travel along the channel, to at least assist in erecting the wall member from an inactive position to an in use position.

2: The inflatable barrier according to claim 1 including a pair of guide formations, and the wall member including a pair of guide members, each of which corresponds with and is at least partially receivable in one of the guide formations.

3: The inflatable barrier according to claim 1 wherein the wall member is manufactured from drop-stitch material.

4: The inflatable barrier according to claim 1 wherein the wall member includes a pair of faces, each of which is substantially planar when the wall member is erected, and/or wherein the pair of faces are substantially parallel with one another.

5: The inflatable barrier according to claim 1 wherein the guide member includes a wheel, at least a part of which is receivable in the channel of the corresponding guide formation.

6: The inflatable barrier according to claim 1 wherein the guide formation forms part of a frame, which may further include a base member.

7: The inflatable barrier according to claim 6 wherein the base member extends substantially perpendicularly to the or each guide formation.

8: The inflatable barrier according to claim 6 wherein the barrier includes an anchor to retain the wall member in a desired position relative to a part of the frame.

9: The inflatable barrier according to claim 8 wherein the anchor includes a Keder rail which is attached to or integral with at least one of the base member and the or each guide formation.

10: The inflatable barrier according to claim 9 wherein the wall member includes a Keder rope which is at least partially receivable in the Keder rail.

11: The inflatable barrier according to claim 10 wherein the Keder rope is attached to the wall member or is integral with the wall member.

12: The inflatable barrier according to claim 1 including at least one seal, for sealing the wall member to the frame and/or the guide member.

13: The inflatable barrier according to claim 1 including an inflation apparatus, which is operable to inflate at least a part of the wall member.

14: The inflatable barrier according to claim 13 which is erectable automatically, by the inflation apparatus being operated in response to a signal provided to a control unit of the inflatable barrier.

15: The inflatable barrier according to claim 14 wherein the signal is an electronic signal, provided by a sensor which is operable to detect one or more conditions which indicate the presence or imminent presence of flood water.

16: The inflatable barrier according to claim 14 wherein the inflatable barrier is manually operable, and manual operation of the inflatable barrier overrides automatic operation of the inflatable barrier.

17: The inflatable barrier according to claim 1 wherein the inflatable barrier includes an energy source.

18: A barrier system including a plurality of barriers, at least one of which is an inflatable barrier according to claim 1.
